(19) United States
(12) Patent Application Publication
(10) Pub. No.: US 2021/0065119 A1
(43) Pub. Date: Mar. 4, 2021

(54) WORKFLOW SYSTEM AND RELATED TECHNIQUES

(71) Applicant: Citrix Systems, Inc., Fort Lauderdale, FL (US)

(72) Inventors: Anuj MAGAZINE, Bengaluru (IN); Praveen Raja DHANABALAN, Bengaluru (IN); Anudeep Narasimhaprasad ATHLUR, Bengaluru (IN)

(21) Appl. No.: 16/558,825

(22) Filed: Sep. 3, 2019

(51) Int. Cl. G06Q 10/10; G06Q 10/06; H04W 4/029

(52) U.S. Cl. CPC G06Q 10/103; H04W 4/029; G06Q 10/063114; G06Q 10/0633

(57) ABSTRACT

Systems and techniques are disclosed for reducing the turnaround time of an approval workflow. The reduction in turnaround time of the approval workflow is achieved by assigning a workflow approval to a proposed approver who is able to tend to the workflow approval within a shorter amount of time relative to the other proposed approvers. For example, an estimated approval time (ETA) can be computed for each approver proposed for processing a workflow approval request. Then, from the computed ETAs, a proposed approver having a computed ETA within a desired range of ETAs can be selected for the workflow approval request. In one example, the selected proposed approver can be assigned to the workflow approval request without input from the workflow owner. In another example, the selected proposed approver can be recommended for assigning to the workflow approval request.

### BACKGROUND

Some conventional workflow systems allow users to electronically collaborate on projects and content. For example, using such a system, a user can create an approval workflow to route documents, requests, forms, tasks, and other items of work for review and approval. Such approval is typically provided by persons, sometimes referred to as “approvers,” “reviewers,” or “administrators.” To secure such approval, the workflow may include a workflow approval request, which is sent to the approvers, reviewers, or administrators to request review and approval of an item of work. Often, an approval workflow may require review and approval by multiple approvers. The multiple approvals may either be sequential, with each approval being contingent upon completion of a prior approval (or rejection), or parallel, wherein multiple approvals (or rejections) can occur simultaneously.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one aspect of the concept described herein, it has been recognized that a delay in securing approval from any one person can adversely affect the performance (completion) of the approval workflow.

Thus, in accordance with one example embodiment provided to illustrate the broader concepts described herein, a system to assign a proposed approver to a workflow approval request may include one or more non-transitory machine-readable mediums configured to store instructions and one or more processors configured to execute the instructions stored on the one or more non-transitory machine-readable mediums. Execution of the instructions may cause the one or more processors to receive information regarding a workflow approval request, receive one or more proposed approvers for processing the workflow approval request, and determine an estimated approval time (ETA) for each of the one or more proposed approvers. Execution of the instructions may also cause the one or more processors to select a proposed approver having a computed ETA which is less than a computed ETA of at least one other proposed approver. In embodiments, the one or more processors select a proposed approver having a computed ETA for the workflow approval request which is less than the computed ETAs for the same workflow approval request for all other proposed approvers (e.g. the one or more processors may select a proposed approver having a minimum ETA for the workflow approval request).

In one aspect, the ETA for a proposed approver may be based on attributes associated with geolocation of a requestor of the workflow approval request and geolocation of the proposed approver.

In one aspect, the attributes associated with geolocation may include one or more of a physical location, a time zone, and a workload.

In one aspect, the physical location attribute may be based on one or more of similarity in language, similarity in dialect, similarity in culture, similarity in business customs, and prior experience working with each other.

In one aspect, one or more of the attributes associated with geolocation may be weighted by a corresponding coefficient.

According to another example embodiment provided to illustrate the broader concepts described herein, a computer-implemented method to assign a proposed approver to a workflow approval request may include receiving information regarding a workflow approval request, receiving a requested due date for the workflow approval request, receiving one or more proposed approvers for processing the workflow approval request, and computing an estimated approval time (ETA) for each of the one or more proposed approvers. The method may also include selecting a proposed approver having a computed ETA for the workflow approval request which satisfied a time criteria. In embodiments, this method may also include selecting a proposed approver having a computed ETA for the workflow approval request which is less than the computed ETA for the same workflow approval request of at least one other proposed approver. In embodiments, this method may also include selecting a proposed approver having a computed ETA for the workflow approval request which is less than the computed ETAs for the same workflow approval request for all other proposed approvers.

In one aspect, the ETA computation for a proposed approver may be based on attributes associated with geolocation of a requestor of the workflow approval request and geolocation of the proposed approver.

In one aspect, the attributes associated with geolocation may include one or more of a physical location, a time zone, and a workload.

In one aspect, the physical location attribute may be based on one or more of similarity in language, similarity in dialect, similarity in culture, similarity in business customs, and prior experience working with each other.

In one aspect, one or more of the attributes associated with geolocation may be weighted by a corresponding coefficient. In one aspect, at least one coefficient may be based on a direction of difference in respective time zones of the requestor and the proposed approver. In one aspect, at least one coefficient may be based on a determination as to whether the time zone of the requestor indicates working hours.

In one aspect, the selected proposed approver may be assigned to the workload approval request.

In one aspect, the selected proposed approver may be recommended for assigning to the workload approval request.

In one aspect, the minimum computed ETA may satisfy a pre-established minimum ETA threshold.

According to yet another example embodiment to illustrative the broad concepts described herein, a computer program product may include one or more non-transitory machine-readable mediums encoding instructions that when executed by one or more processors cause a process to be carried out for assigning a proposed approver to a workflow approval request. The process may include receiving information regarding a workflow approval request, receiving one or more proposed approvers for processing the workflow approval request, and computing an estimated approval time (ETA) for each of the one or more proposed approvers. The process may also include selecting a proposed approver having a desired computed ETA for the workflow approval request. In an embodiment, the desired computed ETA may correspond to a minimum of all proposed approver ETAs.

In one aspect, the ETA for a proposed approver may be based on attributes associated with geolocation of a requestor of the workflow approval request and geolocation of the proposed approver.

In one aspect, the attributes associated with geolocation may include one or more of a physical location, a time zone, and a workload.

In one aspect, the selected proposed approver may be assigned to the workload approval request.

In one aspect, the selected proposed approver may be recommended for assigning to the workload approval request.

In one aspect, a learning algorithm may be used in the assignment of workflows (i.e. in the assignment of a request from a requestor to an approver). For example, a learning algorithm may be used to reduce the number of requests which are initially assigned to one approver and subsequently re-assigned to a second, different approver. By reducing (and ideally eliminating) the number of re-assignments, workflow assignments may be made more efficient over a period of time. In embodiments, such a learning algorithm may use a combination of feedback from requestors and/or information related to re-assignment patterns, (e.g. studying whether a request assigned to one approver was re-assigned to a second, different approver) to reduce the number of requests which are re-assigned.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a block diagram illustrating an example network environment of computing devices in which various aspects of the disclosure may be implemented, in accordance with an embodiment of the present disclosure.

FIG. 1A is a schematic block diagram of a cloud computing environment in which various aspects of the disclosure may be implemented.

FIG. 2 is a block diagram illustrating selective components of an example computing device in which various aspects of the disclosure may be implemented, in accordance with an embodiment of the present disclosure.

FIG. 3 is a block diagram illustrating selected components of an example networked workflow management system that can be used to initiate an improved workflow, in accordance with an embodiment of the present disclosure.

FIG. 4 is a flow diagram illustrating an example process for assigning a workflow approval request to an approver, in accordance with an embodiment of the present disclosure.

FIG. 5 illustrates example interfaces that allow for recommending an approver to assign to a workflow approval request during initiation of a workflow, in accordance with an embodiment of the present disclosure.

FIG. 6 is a flow diagram illustrating an example process for computing an estimated time of approval (ETA) proposed approvers and identifying a proposed approver having a minimum computed ETA, in accordance with an embodiment of the present disclosure.

### DETAILED DESCRIPTION

In the following description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As noted above, an approval workflow may require one or more approvals for completion. To facilitate obtaining of such approvals, existing workflow solutions typically provide a user (e.g., workflow owner) the ability to identify or otherwise specify the person or persons who are to provide the necessary approvals. Often, the persons identified to review and approve the documents, requests, forms, tasks, and other items of work included in an approval workflow may be located in geographically remote locations and in different time zones both from the workflow owner and/or from each other. Further, such persons being relied upon to provide the necessary approvals may be management-level employees who have workloads that keep them very busy (e.g. workloads of a size which prevent such management-level employees from attending to a request within a period of time which does not lead to increased delay times in obtaining an approval). Arbitrarily assigning approval tasks to persons without proper consideration oftentimes results in delays and, in some instances, significant delays in the completion of a workflow.

Some conventional workflow systems utilize dynamic assignments to assign new tasks to underworked and/or underutilized positions or reviewers. Other workflow systems may coordinate concurrent activities to prevent resource or priority conflicts. And still other workflow systems utilize artificial intelligence (AI) to process adjustments and make proposals for further action, However, conventional workflow systems fail to include a mechanism which utilizes geolocation during the selection of a person to review/approve a task. Further conventional workflow systems fail to select an approver based upon an approver's geolocation or based upon one or a combination of the approver's location, time zone, and/or workload.

Thus, and in accordance with an embodiment of the present disclosure, improved workflows, such as improved approval workflows, allow for the securing of necessary approvals in a time efficient manner. The time efficient securing of the necessary approvals provides for reduced turnaround of the workflow processing. For example, certain embodiments automatically assign a workflow approval request for requesting approval of an item of work in a workflow (also referred to herein as a workflow approval request or simply workflow approval for brevity) to an approver or approvers who are able to tend to the workflow approval within a shorter amount of time relative to other approvers capable of processing the workflow approval. In other embodiments, an approver able to tend to a workflow approval within a shorter amount of time relative to other approvers capable of processing the workflow approval is recommended, for example to a user requesting the workflow approval, for assigning to the workflow approval. In any such cases, the improved workflows provided herein are particularly well-suited to reduce or effectively eliminate delays in securing the necessary approvals for a workflow.

In more detail, and in accordance with an embodiment of the present disclosure, a workflow management system is programmed with or otherwise includes a workflow application that is configured to provide a user interface through which a user can initiate or otherwise generate an improved workflow. For example, using such user interface, a user (e.g., workflow owner) can access the workflow management system to initiate a workflow for a process, such as a business process. In initiating the workflow, the user may specify of one or more items of work as part of a workflow process. To continue the example, one work item in the process may be to obtain approval of a document, such as an invoice, a purchase order, an application, a literary work, a budget request, a project plan, a detailed process, or any other collection of information. As part of creating such a work item, the workflow application, according to some embodiments, can identify an approver who is able to perform the task of approving or rejecting the work item (e.g., process a workflow approval request requesting approval of the work item) in the shortest amount of time and assign the workflow approval request to the identified approver. Additionally, or alternatively, the workflow application can identify a suitable approver and recommend the identified approver to the user, and the user can decide as to whether the workflow approval request is to be assigned to the recommended approver.

In some such embodiments, the workflow application determines an approver to assign to or recommend for processing a workflow approval request based on an estimated time of approval (ETA). As used herein, the term ETA generally refers to an estimate of the time required for processing a workflow approval request. For example, when computed for an approver, the ETA for the approver is an estimate of the duration or length of time the approver is expected to take in processing the workflow approval request, once the request is received. In one embodiment, the workflow application can compute an ETA for one or more proposed approvers who are capable of or otherwise authorized to process the workflow approval request and identify an approver associated with the minimum ETA (e.g., smallest ETA) to assign to or recommend for processing the workflow approval request. Numerous other configurations and variations will be apparent in light of this disclosure.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

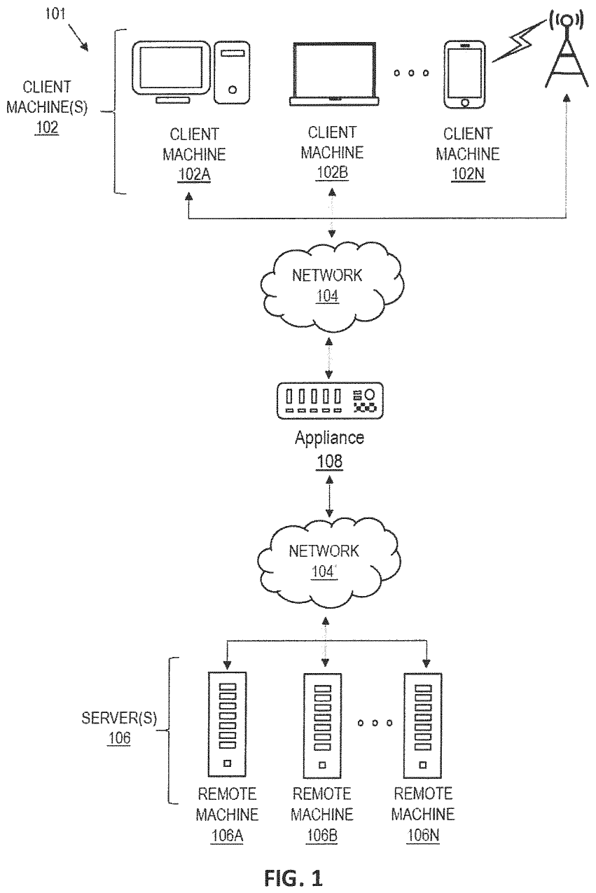

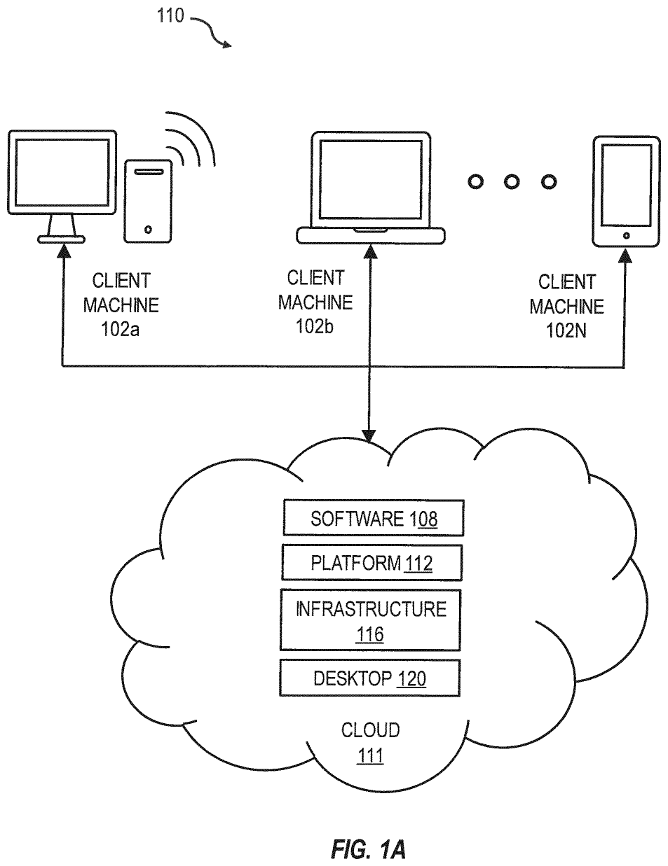

Turning now to the figures, FIG. 1 is a block diagram illustrating an example network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment (e.g. see FIG. 1A), or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

Referring to FIG. 1A, a cloud computing environment 110 is depicted, which may also be referred to as a cloud environment, cloud computing or cloud network. The cloud computing environment 110 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 110, one or more clients 102a-102N (such as those described above) are in communication with a cloud network 111. The cloud network 111 may include back-end platforms, e.g., servers, storage, server farms or data centers. The users or clients 102a-102N can correspond to a single organization/tenant or multiple organizations/tenants. More particularly, in one example implementation the cloud computing environment 110 may provide a private cloud serving a single organization (e.g., enterprise cloud). In another example, the cloud computing environment 110 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 110 may provide a hybrid cloud that is a combination of a public cloud and a private cloud. Public clouds may include public servers that are maintained by third parties to the clients 102a-102N or the enterprise/tenant. The servers may be located off-site in remote geographical locations or otherwise.

The cloud computing environment 110 can provide resource pooling to serve multiple users via clients 102a-102N through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 110 can provide on-demand self-service to unilaterally provision computing capabilities (e.g., server time, network storage) across a network for multiple clients 102a-102N. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 300 can provide an elasticity to dynamically scale out or scale in response to different demands from one or more clients 102a-102N. In some embodiments, the cloud computing environment 300 can include or provide monitoring services to monitor, control and/or generate reports corresponding to the provided shared services and resources.

In some embodiments, the cloud computing environment 110 may provide cloud-based delivery of different types of cloud computing services, such as Software as a service (SaaS) 108, Platform as a Service (PaaS) 112, Infrastructure as a Service (IaaS) 116, and Desktop as a Service (DaaS) 120, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by laaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

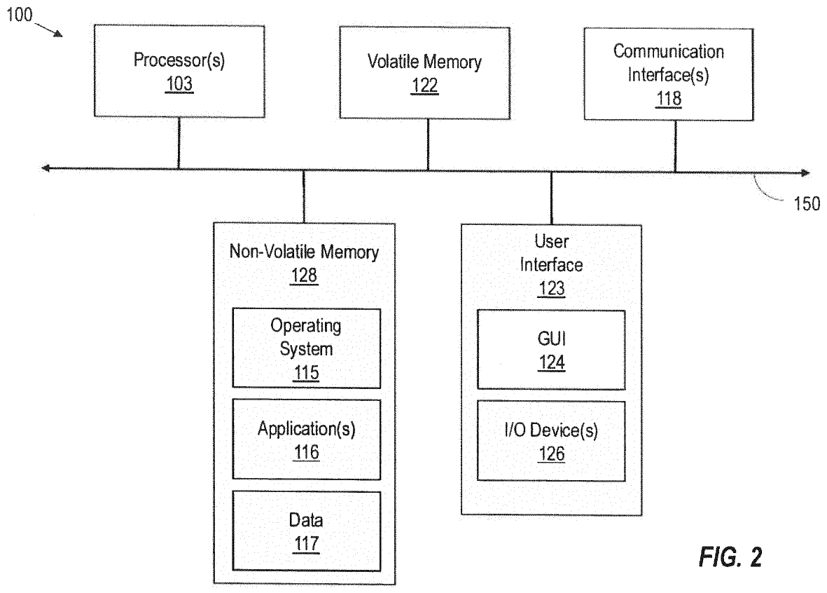

FIG. 2 is a block diagram illustrating selective components of an example computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an example client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed-signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

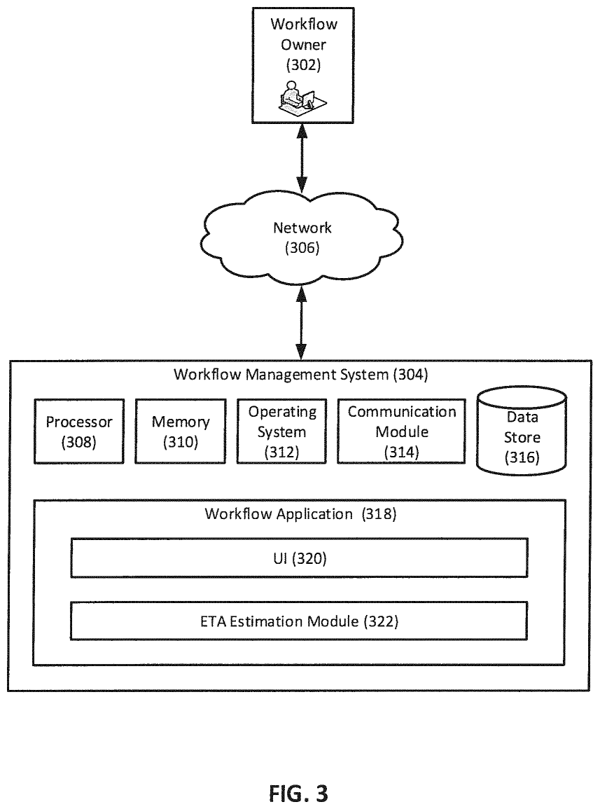

FIG. 3 is a block diagram illustrating selected components of an example networked workflow management system that can be used to initiate an improved workflow, in accordance with an embodiment of the present disclosure. More specifically, the system illustrated in FIG. 3 can be understood as enabling a user, such as a workflow owner 302, for example, to leverage the services of a workflow management system 304. For instance, workflow owner 302 can use the services of workflow management system 304 to initiate an improved workflow that includes one or more workflow approval requests. In the initiated improved workflow, the workflow approval request in the workflow can be assigned so as to reduce the turnaround time of the workflow. In such embodiments, workflow owner 302 can communicate with workflow management system 304 via a network 306. Network 306 can also be used to access supplementary services and resources, some of which may (or may not) be integrated into and provided by workflow management system 304 in some cases. For example, network 306 can be used to access websites, databases, and/or servers of location services, time zone services, and calendaring services, as appropriate. Thus, other embodiments may have fewer or more networks, services, and/or resources depending on the granularity of implementation. It will therefore be appreciated that the embodiments disclosed herein are not intended to be limited to the provision or exclusion of any particular services and/or resources. Further note that the illustrative networked computer system depicted in FIG. 3 is an example only and assumes only a single user. However, it should be understood that the networked computer system depicted in FIG. 3 is easily extended to an arbitrary number of users and their associated devices for use in initiating improved workflows and/or workflow approval requests associated with an improved workflow in accordance with the techniques described herein. For example, a multiple number of users can leverage the services of workflow management system 304. It will therefore be appreciated that the embodiments disclosed herein are not intended to be limited to the use of workflow management system 304 by a single user at any one time.

Network 306 may be a local area network (such as a home-based or office network), a wide area network (such as the Internet), a peer-to-peer network (such as a Bluetooth connection), or a combination of such networks, whether public, private, or both. In certain embodiments, at least a portion of the functionality associated with network 306 may be provided by a cellular data network, thereby making it easier for users of mobile computing devices to leverage the services of workflow management system 304. In general, communications amongst the various entities and resources described herein may occur via wired or wireless connections, such as may be provided by Wi-Fi or mobile data networks. In this regard, network 306 is substantially similar to networks 104 and 104′ described previously with respect to FIG. 1.

As illustrated in FIG. 3, workflow owner 302 has access to a device that facilitates interaction with components of workflow management system 304 illustrated in FIG. 3 or are otherwise described herein. For example, in certain embodiments, workflow owner 302 has access to one or more of a variety of suitable computing devices, including devices such as desktop computers, laptop computers, workstations, enterprise class server computers, handheld computers, tablet computers, cellular telephones, smartphones, and set-top boxes. Other devices may be used in other embodiments. The device or devices used by workflow owner 302 optionally include a wired and/or wireless communication adapter that enables communication via network 306. The device or devices also optionally include input/output components such as one or more of a tactile keyboard, a display, a touch sensitive display, a microphone, a camera, and location services. Such input/output components allow workflow owner 302 to not only control operation of its own device, but also to control certain operational aspects of workflow management system 304.

Referring still to the example embodiment illustrated in FIG. 3, workflow management system 304 can be configured to facilitate the time efficient processing of workflows. In this regard, in some embodiments, workflow management system 304 is configured to facilitate the initiating of an improved workflow and assigning of a workflow approval request to an approver who is able to process the workflow approval request within a shorter amount of time relative to other approvers capable of processing the workflow approval request. To this end, in one embodiment, workflow management system 304 includes one or more software modules configured to implement certain of the functionalities disclosed herein, and optionally further includes hardware configured to enable such implementation. This hardware and/or software may include, but is not limited to, a processor 308, a memory 310, an operating system 312, a communication module 314, and a data store 316.

Processor 308 may be designed to control the operations of the various other components of workflow management system 304. Processor 308 may include any processing unit suitable for use in workflow management system 304, such as a single core or multi-core processor. In general, processor 308 may include any suitable special-purpose or general-purpose computer, computing entity, or computing or processing device including various computer hardware, or firmware, and may be configured to execute instructions, such as program instructions, stored on any applicable computer-readable storage media. For example, processor 308 may include a microprocessor, a central processing unit (CPU), a microcontroller, a digital signal processor (DSP), an application-specific integrated circuit (ASIC), a Field-Programmable Gate Array (FPGA), Complex Instruction Set Computer (CISC), Reduced Instruction Set Computer (RISC), multi core, or any other digital or analog circuitry configured to interpret and/or to execute program instructions and/or to process data, whether loaded from memory or implemented directly in hardware. Although illustrated as a single processor in FIG. 3, processor 308 may include any number of processors and/or processor cores configured to, individually or collectively, perform or direct performance of any number of operations described in the present disclosure. In this regard, processor 308 is substantially similar to processor 103 described previously with respect to computing device 100 of FIG. 2.

Memory 310 may include computer-readable storage media configured for carrying or having computer-executable instructions or data structures stored thereon. Such computer-readable storage media may include any available media that may be accessed by a general-purpose or special-purpose computer, such as processor 308. By way of example, and not limitation, such computer-readable storage media may include non-transitory computer-readable storage media including Random Access Memory (RAM), Dynamic Random Access Memory (DRAM), Synchronized Dynamic Random Access Memory (SDRAM), Static Random Access Memory (SRAM), non-volatile memory (NVM), or any other suitable storage medium which may be used to carry or store particular program code in the form of computer-executable instructions or data structures and which may be accessed by a general-purpose or special-purpose computer. Combinations of the above may also be included within the scope of computer-readable storage media. In this regard, memory 310 is substantially similar to volatile memory 122 described previously with respect to computing device 100 of FIG. 2.

Operating system 312 may comprise any suitable operating system, such as UNIX®, LINUX®, MICROSOFT® WINDOWS® (Microsoft Crop., Redmond, Wash.), GOOGLE® ANDROID™ (Google Inc., Mountain View, Calif.), APPLE® iOS (Apple Inc., Cupertino, Calif.), or APPLE® OS X° (Apple Inc., Cupertino, Calif.). As will be appreciated in light of this disclosure, the techniques provided herein can be implemented without regard to the particular operating system provided in conjunction with workflow management system 304, and therefore may also be implemented using any suitable existing or subsequently developed platform. In this regard, operating system 312 is substantially similar to operating system 115 described previously with respect to computing device 100 of FIG. 2.

Communication module 314 can be any appropriate network chip or chipset which allows for wired or wireless communication via a network or networks, such as network 306 for instance, to one or more of the other components described herein. Communication module 314 can also be configured to provide intra-device communications via a bus or an interconnect. In this regard, communication module 314 is substantially similar to communication interface 118 described previously with respect to computing device 100 of FIG. 2.

Data store 316 may include any type of computer-readable storage media configured for short-term or long-term storage of data. By way of example, and not limitation, such computer-readable storage media may include a hard drive, solid-state drive, Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), non-volatile memory (NVM), or any other storage medium, including those provided above in conjunction with memory 310, which may be used to carry or store particular program code in the form of computer-readable and computer-executable instructions, software or data structures for implementing the various embodiments as disclosed herein and which may be accessed by a general-purpose or special-purpose computer. Combinations of the above may also be included within the scope of computer-readable storage media. Data store 316 may be provided on workflow management system 304 or provided separately or remotely from workflow management system 304. In this regard, data store 316 is substantially similar to non-volatile memory 128 described previously with respect to computing device 100 of FIG. 2.

Workflow management system 304 further includes a workflow application 318, which includes a UI 320 and an ETA estimation module 322. Workflow application 318 is generally configured to provide the overall control of the processing of improved workflows utilizing the services and functionality of user interface module 320 and ETA estimation module 322. In particular, and according to some embodiments, workflow application 318 guides the process of initiating or otherwise generating workflows, for example, in response to input data received via UI 302. As part of initiating a workflow, workflow application 318 can allow for the inclusion of one or more tasks, such as workflow approval requests, which are to be completed as part of the workflow. In some such embodiments, workflow application 318 can utilize ETA estimation module 322 to determine an approver who is able to perform the task (e.g., workflow approval request) in the shortest or shorter amount of time relative to other approvers who are capable of or proposed for performing the task. As will be further described below, according to one embodiment, ETA estimation module 520 can identify such an approver able to perform the task based on computations and comparisons of respective ETAs for each approver determined to be capable of or proposed for performing the task.

In some embodiments, workflow application 318 is configured to assign the identified approver to the particular task. In other embodiments, workflow application 318 is configured to recommend the identified approver for assigning to the particular task. In one implementation, workflow application 318 can present the recommendation to assign the identified approver to the particular task via UI 320. For example, in some such implementations, the recommendation may be presented in a pop-up window during the creation of the particular task or in response to a user, such as workflow owner 302, indicating an approver for assigning to the particular task. In some embodiments, workflow application 318 can also present or otherwise display a list of proposed approvers who are capable of performing the particular task and respective estimated times for processing the particular task for each of the presented approvers. In such embodiments, workflow application 318 can assign the particular task to an approver indicated or otherwise specified by the user, for example, using UI 320.

Workflow application 318 is further configured to process the initiated workflow. In some embodiments, processing of the workflow may include routing the tasks, including the workflow approval requests, along a predefined path until workflow tasks are completed. Routing the tasks may include issuing notifications to perform the tasks and/or triggering or otherwise performing system actions during the processing of the workflow. Workflow application 318 may also collect data (e.g., processing log, error log, and the like) and/or performance metrics (e.g., time taken by an approver to perform a particular task, time taken to perform the entire workflow, number of rejected tasks, number of approved tasks, data regarding backlogs, regarding the functioning or performance of the workflow, and the like). In some such embodiments, workflow application 318 can update information regarding the approver or approvers involved in performing the workflow. For example, workflow application 318 can update information regarding a particular approver to indicate that the approver has past experience working with the requestor of the task performed by the approver, that the approver has experience working with the subject matter of the task, the time taken by the approver to perform the task, and whether the approver approved (or rejected) the task, to provide some examples.

UI 320 is configured to provide a graphical user interface, or other suitable user interface such as a command-line interface, that allows a user, such as workflow owner 302, to interact with workflow application 318. For example, the user may use UI 320 to provide input data (e.g., data regarding a task—e.g., a workflow approval request, a requested due date for the workflow approval request, information regarding one or more approvers capable of processing the workflow approval request, indication of an approver to assign to the workflow approval request, or edits to same) to workflow application 318 to initiate a desired workflow. For instance, the approvers capable of processing the workflow approval request may be those having the necessary authority to approve (or not approve) the workflow approval request. In some such embodiments, UI 320 may be integrated into workflow application 318, or vice-versa.

ETA estimation module 322 is configured to compute an ETA for an approver. In some embodiments, ETA estimation module 322 computes an ETA for an approver, such as an approver who is able to process a workflow approval request, based on an analysis of attributes associated with the geolocation of a requestor of the workflow approval request (e.g., the workflow owner) and the approver for whom the ETA is being computed. Examples of such attributes include physical location, time zone, and workload. In a general sense with respect to the attribute physical location, the premise is that, holding other factors constant, an approver who is based in the same workspace or physical location as the requestor is able to process the workflow approval request faster (i.e., in a shorter amount of time) than an approver who is based in a different workspace or location as the requestor. This disparity in the times to perform the task can be due to congruence in language, dialect, accent, and custom, to provide a few examples. For example, an approver and requestor based at the same physical location may be able to communicate in a common language, dialect, and so on, while an approver physically located in a region remote from the requestor may not be able to communicate in the same language as the requestor. With respect to the attribute time zone, the premise is that, holding other factors constant, an approver who is available in the same or similar time zone and/or working hours as the requestor is able to process the workflow approval request faster. For example, an approver who is situated in a time zone that is behind the time zone of the requester may not be able to tend to the request until the approver is at or available for work later in the day. Conversely, an approver who is situated in a time zone that is ahead of the time zone of the requestor may have already left or stopped working for the day, for example. With respect to the attribute workload, the premise is that, holding other factors constant, an approver with a smaller or less workload (e.g., less work to perform) is able to tend to the request faster than an approver with a larger or more workload. Note that the geolocation attribute workload is applied to the approver and not the requestor since the workload of the requestor should not impact the processing of the request. As will be appreciated in light of this disclosure, an ETA for an approver may be based on an analysis of additional and/or alternative attributes associated with geolocation, and/or various combinations of such additional and/or alternative attributes.

In one specific example embodiment, ETA estimation module 322 can compute an ETA for an approver using the following relation:

ETAₐ=xG+yT+zW [1]

Where subscript a represents the approver, G represents the physical location, T represents the time zone, W represents the workload, and x, y, and z are corresponding coefficients.

For instance, in the above relation, the attribute G may be assigned a value that represents the difference between the approver and the requestor as ascertained from the respective physical locations of the approver and requestor. In one example implementation, the value assigned to G may represent the degree of similarity (or dissimilarity) between the approver and requestor based on factors such as similarity (or dissimilarity) in language, similarity in (or dissimilarity) dialect, similarity (or dissimilarity) in culture, similarity (or dissimilarity) in business customs, and extent of prior experience working with each other, to provide a few examples. In some implementations, a higher value of G corresponds to greater difference (i.e., less similarity) between the approver and the requestor, and a lower value of G corresponds to less difference (i.e., greater similarity) between the approver and requestor.

The attribute T may be assigned a value that represents the difference between the time zone in which the approver is located (e.g., the time zone associated with the physical location of the approver) and the time zone in which the requestor is located (e.g., the time zone associated with the physical location of the requestor). Note that the difference between two time zones can be two different values depending on the counting direction (e.g., the direction of counting from the requestor's time zone to the approver's time zone or vice-versa) and, in such cases, the smaller of the two values represents the smallest time difference and thus can be used for the value of T. For example, if the approver and requestor are located in the same time zone, then the value of T would be zero (i.e. the smallest possible value for T). If the approver and requestor are separated by only one time zone, then the value of T would be greater than zero but may be only a value of one (i.e. the next smallest possible value for T). It should also be noted there are presently 27 time zones around the world, and an approver can be located in a time zone that is 10 time zones ahead of or 17 time zones behind the time zone in which the requestor is located. In this example case, T may be assigned a value of 10, which is the smaller of the two values (10 and 17) that represent the difference in respective time zones of the approver and the requestor. Thus, the smaller the value of T the smaller the difference in time zones. In embodiments the value of T may represent the difference in time zones. In embodiments the value of T may represent the difference in hours or minutes between the requestor and/or approver time zones.

The attribute W may be assigned a value that represents a current workload of or otherwise assigned to the approver. For example, W may be assigned a value that represents an estimate of the number of man hours required to perform the current workload assigned to the approver. In this sense, the value assigned to W may represent the availability of the approver to perform tasks, such as processing the workflow request, other than those already assigned to the approver. The attribute W will also take into account the time needed by the approver to review the workflow. It can be calculated by considering the factors such as number of words in the workflow proposal that can be used to calculate the time taken to read the proposal and take action.

In some embodiments, the coefficients x, y, and z are measures of the weight or importance of the respective geolocation attributes G, T, and W in computing the ETA.

The value of coefficient x may be set and/or adjusted based on the details of attribute G. For example, in the case where the approver and the requestor. One example in which coefficient x may have different values could be if an approver is a manager of a requester, then the system knows that they already have a strong working relationship and hence ‘x’ could be a smaller value. In the same way, if approver is in a different organization ‘x’ could be a higher value.

The value of coefficient y may be set and/or adjusted based on the details of attribute T. For instance, coefficient y may be assigned a value that reflects whether the approver is located in a time zone that is ahead of or behind the time zone associated with the requestor. For example, if a request is initiated at the beginning of a workday, coefficient y may be assigned a larger value if the approver is located in a time zone that is behind the time zone associated with the requestor. This is because businesses or companies in a time zone that is behind the time zone associated with the requestor may not yet be open (i.e. the timing may be such that the companies are not yet in normal business hours which could result in a delay in processing a request). On the other hand, in this situation (i.e. if a request is initiated at the beginning of a workday) a smaller value may be assigned if the approver is located in a time zone that is ahead of the time zone associated with the requestor this is because, in this example, businesses or companies in a time zone that is ahead of the time zone associated with the requestor may already be open (i.e. the timing may be such that the companies are in normal business hours which could avoid a delay in processing a request).

Additionally or alternatively, the value of coefficient y can be set and/or adjusted to reflect whether the time at the location of the approver as indicated by the time zone associated with the approver is during working hours (e.g., time between 9:00 AM and 5:00 PM). For example, the value of coefficient y can be set to a smaller value (e.g., adjusted lower) if the time at the location of the approver is during working hours, and set to a larger value (e.g., adjusted higher) if the time at the location of the approver is outside of working hours. In some example cases, in the case where the time at the location of the approver is during working hours, the degree of adjustment may be based on the number of hours remaining until the end of the working day.

For example, if there are more hours remaining in the working day, the value of coefficient y can be adjusted to a smaller value as compared to the case where there are less hours remaining in the working day, in which case the value of coefficient y can be adjusted to a larger value. This is because it would generally be preferable to assign the request to an approver having more time remaining in the workday to act on the request. Otherwise, an approver may not have enough time to work on the request on the same day the request is received resulting in the approver not working on the request until the next workday. The above, of course, assumes that it is preferable to have an approval request processed or otherwise dealt with during working hours (i.e. during normal business hours) and that the request be acted upon (and ideally completed) so it be done as soon as possible.

Similarly, in the case where the time at the location of the approver is outside of working hours, the degree of adjustment may be based on the number of hours until the start of the next working day. For example, with a requester and an approver located in time zones which are 12 hours apart (with the requestor ahead of the approver) when a requestor sends a request at the end of their workday, the request is received by the approver at the beginning of their workday. The above, of course, again assumes that it is preferable to have an approval request processed or otherwise dealt with during working hours (i.e. during normal business hours) and that the request be acted upon (and ideally completed) so it be done as soon as possible. Thus, in this example, the value of coefficient y can be adjusted to a relatively small value to reflect a large, but in this case favorable, difference in the two time zones (i.e. the requestor time zones, and the approver time zones).

Thus, in some embodiments, the value of coefficient y can be adjusted based on the extent of the difference between the two time zones (i.e., the time zone associated with the approver and the time zone associated with the requestor) while also taking into account the time at which a request is sent. In some embodiments or in some scenarios, for example, the value of coefficient y can be adjusted to a relatively large value (compared to the maximum possible value) to reflect a large difference in the two time zones, and to a relatively small value (compared to the maximum possible value) to reflect a small difference in the two time zones.

The value of coefficient z may be set and/or adjusted based on the details of attribute W. For instance, coefficient z may be assigned a value that reflects the extent of work currently assigned to the approver and an approximation of time the approver will need to complete the currently assigned work. Examples of factors that indicate the extent of work include the volume of currently assigned workload (e.g., the backlog of work), deadlines associated with the items of work in the workload, past experience of the approver in the subject matter of the items of work in the workload, the urgency of completing the items of work in the workload, and the level of complexity or difficulty associated with the items of work in the workload (e.g., an item of work may be trivial, relatively easy, moderate, difficult, very difficult, and so on, to complete), to provide a few examples. For example, based on one or more of such factors, coefficient z may be set to a larger value if the workload currently assigned to the approver is extensive as compared to the case where the currently assigned workload is less extensive, in which case the value of coefficient z may be set to a smaller value. For example, one source of work assigned in an enterprise may be a planning and project tracking system (e.g. as implemented via Jira® computer software) and a defect tracking system (also commonly referred to as a bug tracking system). After scanning both the planning and project and defect tracking systems one can know how many work items need to be completed by a certain time and if this work coincides with the approval workflow time, then z can have higher value (i.e. the workload currently assigned to an approver is larger than the workload of other approvers), otherwise z can have lower value (i.e. indicating that the workload currently assigned to an approver is smaller than the workload of other approvers). Another example may be scanning a calendar of an approver. If the approver's calendar indicates that the approver has one or more meetings during approval workflow time, it can lead to higher z, otherwise a lower value of z may be used.

In some example cases, and as will be appreciated in light of this disclosure, one or more or even all of the coefficients x, y, and z may be omitted from the computation of an ETA for an approver. For example, in one embodiment, an ETA may be computed without using the coefficient y. In some such embodiments, the information conveyed using coefficient y may be reflected in the attribute T. For example, the value of attribute T can also represent the extent of the difference between the time zone associated with the approver and the time zone associated with the requestor.

Thus, in embodiments, an ETA for an approver may be computed using the following relation.

ETAa=G+T+W [2]

That is, one or more of the coefficients may be omitted (or merged) into the attributes G, T, W so as to arrive at a single value for each attribute.

In some embodiments, the information used in computing the ETA, such as approver information, location information, time zone information, and workload data, may be stored or otherwise maintained in a suitable data store, such as data store 316. In one such embodiment, approver information can be maintained in an approver database, location information can be maintained in a location database, time zone information can be maintained in a time zone database, and workload information can be maintained in a workload database. In such embodiments, the information maintained in the various databases may be provided by a data server operably coupled to workflow management system 304. For instance, one data server may be a calendaring service server that provides information regarding the schedules and/or workloads of the approvers. Another data server may be a location services server that provides location information. Another data server may be an internet time server that provides time information. Another data server may be an employee database server that provides information and data regarding the approvers. In some implementations, the information may be retrieved from the various data servers as needed (e.g., in real-time). In other implementations, the information from the various data servers can be retrieved from time to time. However, it will be understood that some embodiments can be implemented without the use of some or all of the data servers. For example, the information provided by such data servers can be determined by workflow management system 304.

In various embodiments, additional components or a subset of the illustrated components can be employed without deviating from the scope of the present disclosure. For instance, other embodiments may integrate the various functionalities of the workflow application, including the UI and the ETA estimation module into fewer modules (e.g., one) or more modules (e.g., three or four, or more). In addition, further note that the various components of the workflow application may be distributed across additional machines. In some cases, the UI and/or the ETA estimation module may be downloaded from a server computing system onto the user device for local execution. In some cases, the functionality provided by the UI and/or the ETA estimation module may be provided on a server computing system communicatively coupled to the user device. In a more general sense, the degree of integration and distribution of the functional component(s) provided herein can vary greatly from one embodiment to the next, as will be appreciated in light of this disclosure.

In embodiments, a learning algorithm may be used in the assignment of workflows (i.e. in the assignment of a request from a requestor to an approver). For example, a learning algorithm may be used to reduce the number of requests which are initially assigned to one approver and subsequently re-assigned to a second, different approver. By reducing (and ideally eliminating) the number of re-assignments, workflow assignments may be made more efficient over a period of time. In embodiments, such a learning algorithm may use a combination of feedback from requestors and/or information related to re-assignment patterns, (e.g. studying whether a request assigned to one approver was re-assigned to a second, different approver) to reduce the number of requests which are re-assigned.

For example, a request made by a requestor based in the U.S. (i.e. physically located in the U.S.) may initially be routed to an approver in China. The geographical separation between the requestor and the approver and known language issues, may lead one to expect this to result in a value of G (or the co-efficient corresponding to G) being relatively high. However, if good turnaround times and good feedback have been experienced on similar requests and/or requestor/approver pairs in the past (e.g. a requestor based in the U.S. and an approver based in China) a learning algorithm may gradually lower the value of G (or the co-efficient corresponding to G) which may result in the probability of an approver in China being assigned a new workflow request from a U.S. based requestor being increases going forward. On the other hand, if good turnaround times and good feedback have not been experienced on similar requests and/or requestor/approver pairs in the past (e.g. similar past requests have been re-assigned to another approver in a different geographic region—i.e. some geographic region other than China, in this example), this may lead to a higher value of G (or its coefficient) and hence mean that going forward, requests from a U.S.-based requestor would be less likely to be routed to an approver based in China (i.e. a poor prior experience would result in the probability that a request from a requestor based in the U.S. would be assigned to an approver based in China being lower compared to a probability which would result from a positive prior experience with a request from a requestor based in the U.S. assigned to an approver based in China).

The embodiments described herein can be implemented in various forms of hardware, software, firmware, or special purpose processors. For example, in one embodiment, a non-transitory computer readable medium includes instructions encoded thereon that, when executed by one or more processors, cause aspects of workflow management system 304 described herein to be implemented. The instructions can be encoded using any suitable programming language, such as C, C++, object-oriented C, Java, JavaScript, Visual Basic .NET, BASIC, Scala, or alternatively, using custom or proprietary instruction sets. Such instructions can be provided in the form of one or more computer software applications or applets that are tangibly embodied on a memory device, and that can be executed by a computer having any suitable architecture. In one embodiment, the system can be hosted on a given website and implemented, for example, using JavaScript or another suitable browser-based technology to facilitate, for example, the initiation of improved workflows described herein.

The functionalities disclosed herein can optionally be incorporated into a variety of different software applications and systems, including project management systems and applications, purchasing systems and applications, invoicing systems and applications, document authoring systems and applications, hiring requisition approval systems, travel expense approval systems, human resource (HR) systems (e.g. like workday), to name a few. The functionalities disclosed herein can additionally or alternatively leverage services provided by separate software applications and systems. For example, in one embodiment, the functionalities disclosed herein can be implemented in a cloud environment, such as Microsoft® Azure®, AWS®, Google Cloud™, or any suitable cloud environment. Additionally or alternatively, the functionalities disclosed herein can be implemented using an IaaS framework. The computer software applications disclosed herein may include a number of different modules, sub-modules, or other components of distinct functionality, and can provide information to, or receive information from, still other components and services. These modules can be used, for example, to communicate with input/output devices such as a display screen, a touch sensitive surface, auditory interface, a digital camera, or any other suitable input/output device. Other components and functionality not reflected in the illustrations will be apparent in light of this disclosure, and it will be appreciated that the present disclosure is not intended to be limited to any particular hardware or software configuration. Thus, in other embodiments, the components illustrated in FIG. 3 may include additional, fewer, or alternative subcomponents. Furthermore, in some cases, one or more of the modules and components illustrated in FIG. 3 may be downloaded from a server computing system onto a user device for local execution.

In alternative embodiments, the computers and modules disclosed herein can be implemented with hardware, including gate level logic such as a field-program mable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used in this regard, and that the present disclosure is not intended to be limited to any particular system architecture.

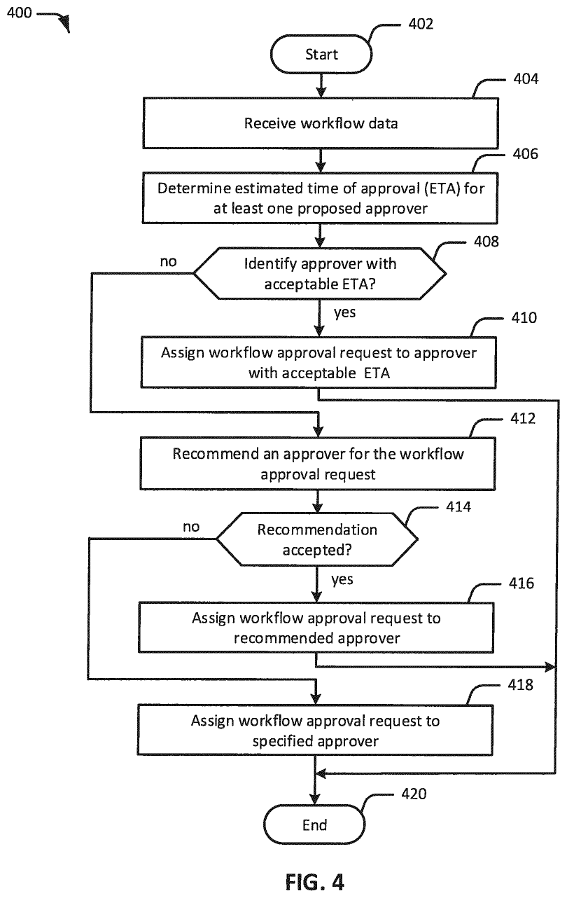

FIG. 4 is a flow diagram illustrating an example process 400 for assigning a workflow approval request to an approver, in accordance with an embodiment of the present disclosure. The operations, functions, or actions illustrated in example process 400, and example process 600 further described below, may in some embodiments be performed by various components of workflow application 318 of FIG. 3. The operations, functions, or actions described in the respective blocks of example process 400, and example process 600, may also be stored as computer-executable instructions in a computer-readable medium, such as memory 310 and/or data store 316 of workflow management system 304 of FIG. 3.

As will be further appreciated in light of this disclosure, for this and other processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

With reference to FIG. 4, process 400 is initiated at block 402. At block 404, information regarding workflow data is received. Such workflow data may include, but is not limited to, a workflow approval request, requested due date for the workflow approval request. and one or more proposed approvers. It should be appreciated that one purpose of the due date, simply, is to mandate a date by which review/approval needs to be finalized. It is a part of workflow process. If the calculated ETA is beyond due date, then the algorithm should give an alert to the workflow creator.

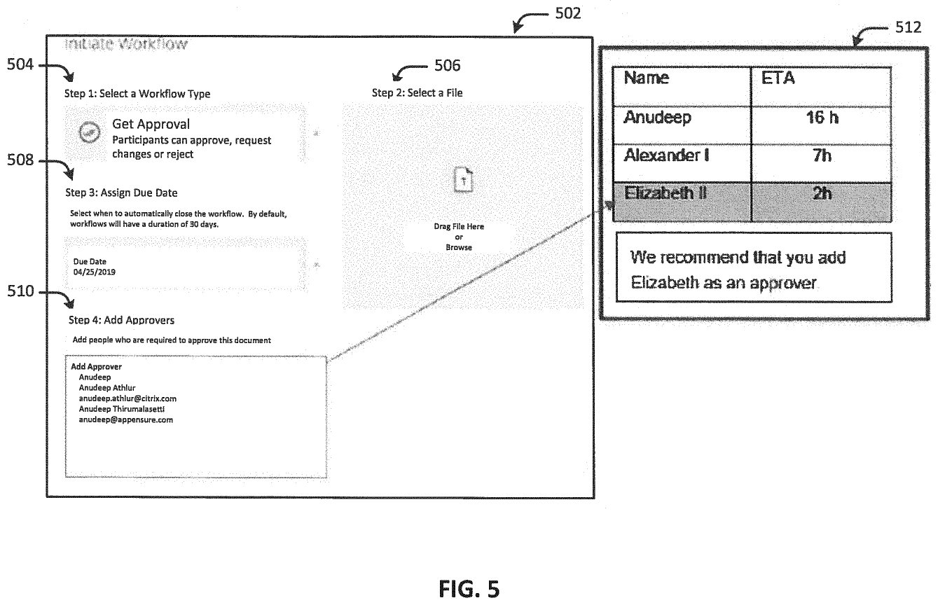

As previously described, the workflow approval request may be received as part of an initiation of a workflow. For example, such information regarding the workflow approval request may be input by a user utilizing an example interface 502, as illustrated in FIG. 5. In one example implementation, interface 502 may be included in or as part of a user interface, such as UI 320 or workflow application 318. As can be seen in FIG. 5, interface 502 can include interface elements 504, 506, 508, and 510. Interface element 504 can be used to input or otherwise select a workflow type. The workflow type defines or otherwise specifies the type of action or task that is being requested. Examples of workflow types include, but are not limited to: get approval and request review to provide two examples.

In this example case of a workflow approval request, interface element 504 can be used to input or otherwise select “Get Approval” as shown in FIG. 5. Interface element 506 can be used to input or otherwise select a document or file. This document or file is the “subject” of the requested action or task. In the example case of the workflow approval request, the request is for approval of the information (or data) contained in the document or file. Interface element 508 can be used to input or otherwise specify a due date for the requested action or task. For instance, the due date may be a requested completion date for completing the requested action or task. Interface element 510 can be used to input or otherwise indicate one or more persons to assign to the requested action or task. For example, in one implementation, a list of persons capable of performing the requested action or task (e.g., one or more persons proposed to perform the requested action or task) can be presented in interface element 510, and a user can select one or more persons from the list. In some such implementations, the presented list can include the name of the person and contact information, such as an email address, for the named person. In the example case of the workflow approval request, interface element 510 can be used to present a list of proposed approvers and receive input or otherwise selection of one or more proposed approvers to assign to the workflow approval request. In embodiments, the type and due date may be automatically generated based upon a document upload. For example, if an expense report is uploaded then a policy/rule could be to have this report approved within 15 days and associate it with a particular request type.

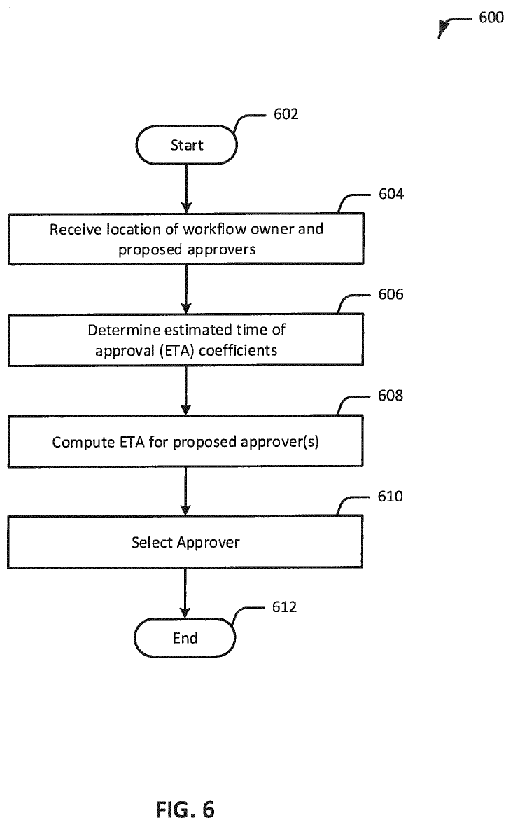

Referring again to process 400 of FIG. 4, at block 406, an ETA is determined for each proposed approver. FIG. 6 provides further details for computing or otherwise determining an ETA for each proposed approver, according to some embodiments.

Processing then proceeds to decision block 408, at which a determination is made as to whether any proposed approver was identified as having an ETA suitable for the needs of the particular request. In embodiments, a suitable ETA may correspond to a minimum ETA (i.e. an ETA indicating the shortest amount of time of all ETAs computed or otherwise determined for a plurality of approvers proposed for the same request) and which also satisfies the due date. In the case where a minimum ETA is used, in decision block 408 a determination is made as to whether an approver with a minimum ETA is identified.

In some embodiments, a proposed approver is identified as having a minimum ETA if the ETA computed for that particular proposed approver satisfies a pre-established minimum ETA threshold. If the computed ETA does not satisfy the pre-established minimum ETA threshold, then the proposed approver associated with that ETA may not be selected (e.g., identified) as a proposed approver having a minimum ETA. In the case where an approver with a suitable ETA is identified, processing proceeds to processing block 410 in which the workflow approval request is assigned to an approver having a suitable ETA. In embodiments, the workflow approval request is assigned to an approver having a minimum ETA. Processing is then complete. Thus, in summary, if a proposed approver is identified as having an acceptable ETA (which may be a minimum ETA), then at block 410, the workflow approval request is assigned to the identified proposed approver having the acceptable ETA. As noted above, in some embodiments, this may be a minimum ETA while in other embodiments, another ETA. In some embodiments, a notification of the assignment of the workflow approval request to the identified proposed approver can be provided, for example, using UI 320. Process 400 then ends at block 420.

In embodiments, the processes performed in processing/decision blocks 406-410 may be repeated to ensure that the assigned approver is still the best one. For instance, if approver X concurrently receives several requests, the time for approvals by approver X now increases. Thus, the system may re-check the time and then re-assign one or more previously assigned request (i.e., ones currently assigned to approver X) to another approver to avoid a bottleneck.

If in decision block 408 none of the proposed approvers is identified as having an acceptable (e.g. a minimum) ETA, then processing proceeds to processing block 412 at which one of the proposed approvers can be selected and recommended for assigning to the workflow approval request. For example, in the case where multiple proposed approvers have the same acceptable ETA (e.g. the same minimum ETA), one of these proposed approvers can be selected and recommended for assigning to the workflow approval request. Alternatively, in the case where none of the computed ETAs satisfies a pre-established ETA threshold (e.g. based upon a due date), in processing block 412 the proposed approver having the smallest computed ETA can be selected and recommended for assigning to the workflow approval request. Such a recommendation may be presented, for example, by utilizing an interface. One example of a suitable interface is described below in conjunction with FIG. 5.

At decision block 414, a check is made to determine whether the recommendation of the proposed approver (i.e., proposed approver recommended for assigning to the workflow approval request) is accepted. For example, the recommendation can be made to the user, and the user can either accept or refuse the recommendation. If the recommendation is accepted, then, at block 416, the recommended proposed approver is assigned to workflow approval request. Process 400 then ends at block 420.

Otherwise, if the recommendation is not accepted, then, at block 418, the workflow approval request is assigned to a proposed approver (e.g. an approver recommended by the workflow owner or by some other person or entity) different from the recommended proposed approver. For example, in one implementation, the workflow approval request can be assigned to an approver specified or otherwise proposed by the user. In some such implementations, the user can specify an approver to assign to the workflow approval request using interface 502 and/or 512 illustrated in FIG. 5. Process 400 then ends at block 420. This may, for example, be desirable in a case in which a request is related (e.g. closely related) to one or more previous requests handled by the same approver. In this case, such a factor (i.e. prior experience between a requestor and a proposed approver or prior experience between a proposed approver and a particular request type or particular subject in a request) may outweigh other factors in selecting a preferred approver.

Referring now to FIG. 5, in one example implementation, an interface 512 may be a pop-up window that is presented in conjunction with the use of interface element 510. As can be seen in FIG. 5, interface 512 can display the names of the proposed approvers and the respective computed ETA for each of the displayed proposed approvers. The proposed approver who is being recommended can be appropriately indicated (e.g., via highlighting, underlining, differentiated text, differentiated font, and the like) in interface 512. Interface 512 can also display the text recommending the indicated proposed approver for assigning to the workflow approval request. Note that in instances where there are a large number of proposed approvers, interface 512 may be implemented using a scroll bar.

Referring now to FIG. 6, an example process 600 for computing an estimated time of approval (ETA) for proposed approvers and identifying a proposed approver having a minimum computed ETA, is initiated at processing block 602. At processing block 604, information regarding the locations of the workflow owner and the proposed approvers is received. The workflow owner may be the user initiating the workflow. In one example implementation, the ETA for each proposed approver can be computed using relation [1] described above. In such implementations, the location information may be used in determining the values of one or more of the attributes G, T, and W.

At processing block 606, a determination is made as to which of the ETA coefficients x, y, and z (e.g. one, some, none or all) are to be used in computing the ETA using relation [1]. For example, in one implementation, all three coefficients x, y, and z may be used in computing the ETA. In other implementations, a subset of the three coefficients (e.g., x, y, z, x and y, x and z, or y and z) may be used in computing the ETA. Similarly, in the case where the coefficients x, y, z, are merged into attribute G, T, W all three attributes G, T, W may be used in computing the ETA, as shown in Equation [2] for example. In other implementations, any subset of the three attributes (e.g., G, T, W) may be used in computing the ETA.

At processing block 608, an ETA can be computed for at least one of the proposed approvers. For example, to save processing power, the system could simply select an approver that is below the threshold so that it does not have calculate the time for all approvers.

At processing block 610, a proposed approver having a computed ETA which is suitable (for example, a minimum ETA) can be selected. A proposed approver having a minimum (as an example) ETA is the approver who can process the task, i.e., the workflow approval request, in the shortest amount of time (e.g., start processing the task in the shortest amount of time). Process 600 then ends at block 612.

To provide one simple illustrative example of using relation [1] to compute ETAs for proposed approvers, suppose a workflow owner located in Bangalore, India needs an approval for a workflow approval request, and the request is being made at 10:00 hrs India Standard Time (IST). Further suppose that there are four proposed approvers, PA 1, PA 2, PA3, and PA4, in an approval committee, and the respective locations and workloads for the four proposed approvers are as follows:

| Approver | Location | Workload | Resolution Time | |
|---|---|---|---|---|
| PA 1 | China | 2 T1, 4 T5 | 4 | hours |
| PA 2 | China | 1 T1, 2 T5 | 2 | hours |
| PA 3 | US | 2 T1, 5 T5 | 4.5 | hours |
| PA 4 | US | 2 T1, 3 T5 | 3.5 | hours |

where “Location” corresponds to a location of a proposed approver, “Workload” corresponds to a current workload of a proposed approver, Tx corresponds to a level of complexity of a workload item, and “Resolution Time” indicates an estimate of the time needed to complete the work items in the current workload. For example, as to levels of complexity, T1 may indicate a trivial task and T5 may indicate a very complex task. Thus, in the above example, PA 1 has a current workload of 2 T1 items and 4 T5 items, PA 2 has a current workload of 1 T1 item and 2 T5 items, PA 3 has a current workload of 2 T1 items and 5 T5 items, and PA 4 has a current workload of 2 T1 items and 3 T5 items.

Further, based on historical performance metrics, typical times to complete a workload item of varying levels of complexity can be estimated. For example, a T1 item can be estimated to take 0.5 hours to complete and a T5 item can be estimated to take 1 hour to complete. Since the workflow owner is submitting the workflow approval request at 10:00 hrs IST, the proposed approvers located in China (i.e., PA 1 and PA 2) may be better for performing the workflow approval request since it is past working hours in the US. Continuing the example, since PA 2 has a lesser cumulative workload than PA2 (e.g., estimated workload resolution time of 2 hours versus estimated workload resolution time of 4 hours) proposed approver PA 2 can be identified for assigning to the workflow approval request. In embodiments, historical performance metrics may be obtained, determined or otherwise provided via any form of task management software to track a current open action items to parse through past requests and compute the average resolution time taken based on the priority, location, etc. For example, task management software, such as Jira®, used by an individual and/or an organization implementing the concepts described herein may be used to obtain, determine or otherwise help provide historical performance metrics.

In some embodiments, additional operations are performed. For example, in some embodiments, the user may add a proposed approver for a workflow approval request. In response to the user adding a proposed approver, workflow application 318 can display a list of all proposed approvers, including the proposed approver just added by the user, along with the respective ETA for each of the proposed approvers.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A system comprising:
a memory; and
one or more processors in communication with the memory and configured to:
receive information regarding a workflow approval request, the information including at least some geolocation data and workload data for at least one approver of the workload approval request;
determine an estimated time of approval (ETA) for the at least one approver based on the received geolocation data and workload data;
select at least one approver to approve the workflow approval request based upon the determined ETA for the at least one approver being less than at least one of: an ETA for the same workflow approval request for at least one other approver; and a threshold value; and
initiate the workflow in response to selection of the at least one approver to complete the desired action.

2. The system of claim 1, wherein the ETA for an approver is based upon attributes associated with geolocation of a requestor of the workflow approval request and geolocation of the approver.

3. The system of claim 2, wherein the attributes associated with geolocation include one or more of: a physical location; a time zone; and a workload.

4. The system of claim 3, wherein the physical location attribute depends upon one or more of: a geographic location, similarity in language; similarity in dialect; similarity in culture; similarity in business customs; and prior experience between a requestor and a proposed approver.

5. The system of claim 2, wherein one or more of the attributes associated with geolocation is weighted by a corresponding coefficient.

6. The system of claim 6, wherein the value of at least one coefficient is determined based upon at least one of: similarity in language; similarity in dialect; similarity in culture; similarity in business customs; and prior experience between a requestor and a proposed approver.

7. A computer-implemented method to assign a proposed approver to a workflow approval request, the method comprising:
receiving information regarding a workflow approval request, the information including at least some geolocation data and workload data for at least one approver of the workload approval request;
determining an estimated time of approval (ETA) for the at least one approver based on the received geolocation data and workload data;
selecting at least one approver to approve the workflow approval request based upon the determined ETA for the at least one approver being less than at least one of:
an ETA for the same workflow approval request for at least one other approver; and a threshold value; and
initiating the workflow in response to selection of the at least one approver to complete the desired action.

8. The computer-implemented method of claim 7, wherein determining the ETA for the at least one approver based on the received geolocation data and workload data is based on attributes associated with geolocation of a requestor of the workflow approval request and geolocation of the proposed approver.

9. The computer-implemented method of claim 8, wherein the attributes associated with geolocation include one or more of: a physical location; a time zone; and a workload.

10. The computer-implemented method of claim 8, wherein the physical location attribute is based upon one or more of: a similarity in language; a similarity in dialect; a similarity in culture; a similarity in business customs; and prior experience working with each other.

11. The computer-implemented method of claim 8, wherein one or more of the attributes associated with geolocation is weighted by a corresponding coefficient.

12. The computer-implemented method of claim 11, wherein at least one coefficient is based upon a direction of difference in respective time zones of the requestor and the at least one approver.

13. The computer-implemented method of claim 11, wherein at least one coefficient is based upon a determination as to whether the time zone of the requestor indicates working hours.

14. The computer-implemented method of claim 7, wherein the selected at least one approver is assigned to the workload approval request.

15. The computer-implemented method of claim 7, wherein the selected he selected at least one approver is recommended for assigning to the workload approval request.

16. The computer-implemented method of claim 7, wherein the minimum computed ETA satisfies a threshold.

17. One or more non-transitory machine-readable mediums encoding instructions that when executed by one or more processors cause a process to be carried out, the process comprising:
receiving information regarding a workflow approval request, the information including at least some geolocation data and workload data for at least one approver of the workload approval request;
determining an estimated time of approval (ETA) for the at least one approver based on the received geolocation data and workload data;
selecting at least one approver to approve the workflow approval request based upon the determined ETA for the at least one approver being less than at least one of: an ETA for the same workflow approval request for at least one other approver; and a threshold value; and
initiating the workflow in response to selection of the at least one approver.

18. The media of claim 17, wherein determining the ETA for the at least one approver comprises determining the ETA for the at least one approver based upon at least one of: attributes associated with geolocation of a requestor of the workflow approval request; and geolocation of the proposed approver.

19. The media of claim 18, wherein the attributes associated with geolocation include one or more of: a physical location; a time zone; and a workload.

20. The media of claim 17, further comprising at least one of:
assigning the selected at least one approver to the workload approval request; and
recommending the selected at least one approver for assignment to the workload approval request.
